(19) United States
(12) Patent Application Publication
(10) Pub. No.: US 2013/0262030 A1
(43) Pub. Date: Oct. 3, 2013

(54) Method of Determining Weight Of Segments Of An Item

(71) Applicants: John R. Benefiel, West Bloomfield, MI (US); Kenneth Wargon, West Bloomfield, MI (US)

(72) Inventors: John R. Benefiel, West Bloomfield, MI (US); Kenneth Wargon, West Bloomfield, MI (US)

(21) Appl. No.: 13/623,248

(22) Filed: Sep. 20, 2012

Related U.S. Application Data
(63) Continuation of application No. 12/641,927, filed on Dec. 18, 2009, now abandoned.

(51) Int. Cl. G01G 9/00

(52) U.S. Cl. CPC G01G 9/00
USPC 702/173

(57) ABSTRACT

A method of measuring the weight of mass of incremental sections of an item using protraction of radiation through each section and measuring the intensity of radiation after passing through the item. The weight can be summed to determine the weight of any segment of the item.

### CROSS REFERENCE TO RELATED APPLICATIONS

This application is a continuation of U.S. application Ser. No. 12/641,927 filed on Dec. 18, 2009, which claims the benefit of U.S. provisional application Ser. No. 61/203,055 filed on Dec. 18, 2008.

### BACKGROUND OF THE INVENTION

This invention relates to the apparatus and methods as described in U.S. Pat. Nos. 7,010,457; 7,158,915; and 7,158,915 as well as in publication U.S. 2008/0221829 A1, incorporated herein by reference.

Those patent references describe determination of parameters related to the volume of any selected segment of an item such as weight or price of the segment by determining cross-sectional of successive sections while detecting distances a sensor bar is moved along the item in moving from a position over one section thereof to another position over another section. The part of the item between those positions defines a segment of the item. The segment volume is determined by multiplying the average cross sectional area times the length of the segment. The weight of the segment is then determined from predetermined density stored in a look up table.

The need to assign a density value to an item complicates the weight determination process. While a density sensor could obviously be added to the apparatus to obviate the need to look up and assign a density value to the item, this would increase the complexity and cost of the apparatus. Also, the density of the item may vary and this could affect the accuracy of the determination

It is an object of the present invention to directly determine the weight of incremental cross sections of an item without separately determining either the cross sectional areas of incremental sections of an item or the density of the item.

### SUMMARY OF THE INVENTION

The above recited object is achieved in one embodiment by the use of one or more radiation sources and one or more radiation detectors respectively positioned on either side of the item without the need to determine either the density or the cross sectional areas along the item segment.

Such radiation sources (emitting radiation such as beta and/or gamma rays) and radiation detector arrangements are known and used in determining thickness or density of an item such as described in U.S. Pat. No. 4,182,954 incorporated herein by reference.

Since two variables are involved, either the density or the thickness must be known to find the other parameter.

The attenuation of radiation in passing through a body varies with both the penetrated thickness of the body and the density of the body. The product of the density and thickness therefore corresponds to the mass or weight of a cross-section of the item which is penetrated by the radiation beams.

Thus a direct correspondence exists between the total mass or weight of an examined section and the attenuation of the radiation passing through that section. The average mass of all of the sections of a segment of a body times total number of sections equals the total mass or weight of the segment. The present invention a determine the mass of a cross section, based on a sampling increment. That is, the total mass or weight of a section of an item is obtained by determining the attenuation of radiation passed through the section. The correlation between the mass per slice or section and the degree of attenuation of the radiation is determined by a calibration process. The average of the cross sectional masses is multiplied by the total number of slices taken, i.e. the number of sections sampled along an item. Alternatively, the mass or weight of each section may be summed to arrive at a total mass of that segment.

As noted, by a calibration process for the set up involved with test samples of varying known thicknesses and density, the relationship between the attenuation of radiation in passing through a body and the mass or weight of a given section of an item can be determined. By use of a displacement detector or by setting a constant sampling distance the total number of slices can be counted up, and, the total mass or weight of any traversed segment of an item can then be computed.

By sampling at predetermined increments of displacement and averaging the masses of a number increments of the item and totaling the increments of the item in passing a segment of the item by the radiation source or sources, the total mass (or weight) of the item segment of interest being the number of increments multiplied by the average mass of all of the increments traversed. That is, the product of the average cross sectional mass times the number of sample sections which are contained in the segment equals the total mass (or weight) of the item segment. The thickness of a cross section sample is determined by the sampling increment and would be a substantially constant value established for the particular equipment used. By summing all of the slice mass readings during movement along the length of the item, a total mass for any segment can be computed. The density and cross sectional area of each increment is assumed to be constant over the thickness of the increment and thus is an approximation which is more accurate the smaller the increment.

Accordingly, sensing or calculation of cross sectional areas or look up tables of density are not required. The average density of an item is automatically accounted for by the method of the invention such that density values do not have to be determined prior to carrying out the measurements of the mass (i.e., weight) of segments of an item.

In this instance, a bidirectional power transporter may be used to create relative displacement of the item in either direction past fixed radiation sources and one or more radiation detectors at a fixed location.

Alternatively, penetrating electromagnetic waves such as infrared (IR) radiation may be directed at the item from a source on a manually moveable and held member and a detector also on the member sensing intensity of the IR reflected from the item supported on a table surface while penetrating the nonmetallic item. The attenuation of intensity would correspond to the mass of the item at the section penetrated.

This allows directly determining the weight of any segment of the item as developed above.

This method is particularly suitable where similar types of items are to be scanned, i.e., different species of fish, etc. as the correspondence between cross sectional masses and attenuation of radiation will be closer.

### DESCRIPTION OF THE DRAWING FIGURES

FIG. 1 is a diagrammatic side view representation of a measuring set up according to the invention;

FIG. 2 is a plan view of the set up shown in FIG. 1 with a block diagram representation of associated components.

FIG. 2A is a plan view diagrammatic representation of successive sample sections through an item being examined.

FIG. 3 is a side view diagrammatic representation of an alternative embodiment of a measuring set up according to the invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

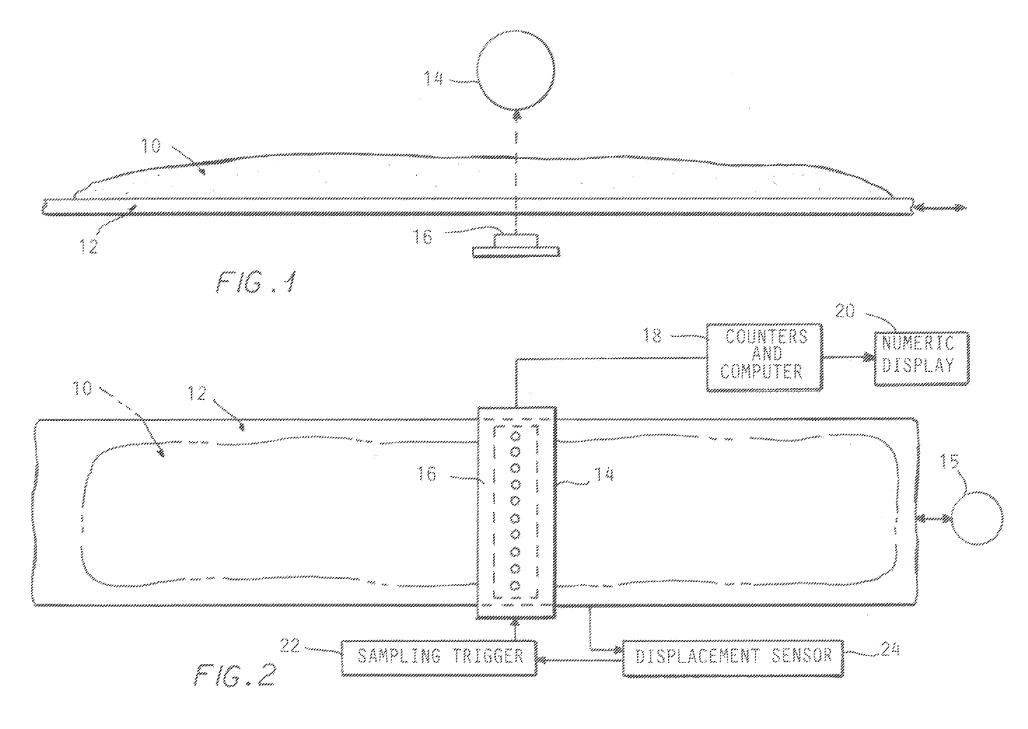

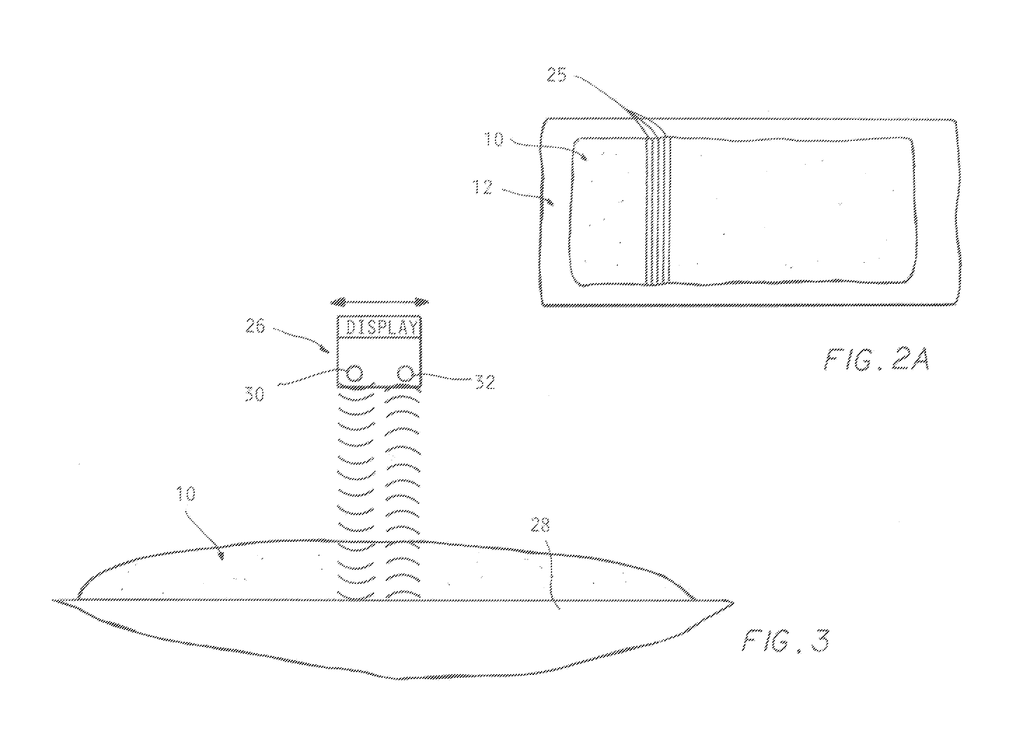

Referring to FIGS. 1 and 2 and item 10 to be examined is disposed on a transporter 12 such as a conveyor belt to be advanced relative to a relatively fixed station where a detector tube 14 and an array of radiation services 16 are aligned above and below the transporter 12. Radiation emitted from the sources 16 passes through the item 10 to the detector 14. Variations in thickness and/or density cause variations in the intensity of radiation measured by the detectors 14.

The corresponding signals are sent to a signal processor/counter 18 and thence to a numeric display 20.

The item 10 is relatively moved to present successive sections to the radiation source in predetermined increments as by a sampling control 22. A displacement sensor 24 coordinates the sampling of the total weight/mass of successive increments of the item which can be displayed in the numeric display 20.

The weight of each section can be totaled for a given segment to determine the weight of any segment of the item 10 without the need to account the density of the item or the thickness of cross sectional areas as the product of these parameters are determined by the extent of attenuation of the radiation intensity.

The item 10 could be made stationary and the radiation source 16/detector 14 moved along the item 10.

FIG. 2A shows a series of sections 25 of the item 10 being measured which can be of a programmed width depending on the accuracy desired.

Empirical testing can be used to determine the correlation between the mass/weight of an item and the intensity of radiation after passing through the item, and periodic calibrations can be performed. This would vary with the product thickness and intensity.

FIG. 3 shows a combined radiation source-detector 26 which could freely move manually along the item 10 on a stationary table 28.

A source of radiation 30 transmits penetrating the item such as infrared which reflects from the table surface to return to a sensor 32 to determine the intensity of the reflected wave which will vary with the total mass/weight of each section of the item 10. The material of the table and the frequency of the infrared are selected so that the infrared radiation will be reflected, while penetrating the item 10.

1. A method of measuring the weight of a segment of an item comprising:
directing radiation at the item to penetrate successive incremental sections of said item;
determining the intensity of radiation passing through a series successive sections of said item comprising the segment of said item;
calculating the weight of each section from the detected intensity of radiation passed through each section of the item; and
displaying a corresponding numeric value to the combined weight of said sections of said item, whereby the weight of said segment of radiation is displayed.

2. The method according to claim 1 wherein said item is relatively indexed with respect to radiation source and radiation detector to expose successive sections to penetration by radiation.

3. The method according to claim 1 wherein said radiation is reflected back from a support surface on which said item rests through said item towards said sensor after again passing through said item.
